(19) United States
(12) Patent Application Publication
(10) Pub. No.: US 2020/0150210 A1
(43) Pub. Date: May 14, 2020

(54) METHOD, APPARATUS, AND COMPUTER PROGRAM PRODUCT FOR DETERMINING POSITION OF A DEVICE BASED ON SOUND

(71) Applicant: HERE GLOBAL B.V., Eindhoven (NL)

(72) Inventors: Marek KRYSIUK, Berlin (DE); Agnieszka MICHALIK, Berlin (DE)

(21) Appl. No.: 16/189,645

(22) Filed: Nov. 13, 2018

(51) Int. Cl. G01S 3/801; G01S 15/06

(52) U.S. Cl. CPC G01S 3/801; G01S 15/06

(57) ABSTRACT

A method, apparatus, and computer program product for determining a refined position of a mobile device. The method comprises determining an initial position of the mobile device and determining a segment of a road associated with the initial position of the mobile device. The method further comprises determining a candidate pattern in sound data recorded via a plurality of microphone sensors of the mobile device. The method further comprises determining the refined position of the mobile device based on the initial position of the mobile device, the candidate pattern and the determined segment of the road.

### FIELD OF THE PRESENT DISCLOSURE

An example embodiment of the present invention generally relates to mapping and navigation applications, and more particularly relates to a method, apparatus, and computer programmable product for determining accurate position of a device.

### BACKGROUND

Various navigation applications are available to provide directions for driving, walking, or other modes of travel. Web sites and mobile applications offer map applications that allow a user to request directions from one point to another. Navigation devices based on Global Positioning System (GPS) technology have become common, and these systems are capable of determining the location of a device to provide directions to drivers, pedestrians, cyclists, and the like. However, quite often there may be errors/offsets in the determined position of a device when compared with the actual position. For example, commonly available navigation systems such as Global Navigation Satellite Systems (GNSS), e.g. GPS, and network-based positioning systems suffer from accuracy issues when it comes to determining intricate details regarding the location of a device. Especially, there is often an offset in the location of the device as determined by these systems and the actual location of the device. As such, the location determined by these systems are inaccurate and not suitable for applications requiring precise positioning.

In applications providing navigation assistance, it may be required to provide information regarding the side of the street the user carrying the device is on, to precisely provide the navigation assistance. Available navigation systems depend on signal quality to deduce precision in positioning, thereby requiring dedicated and costly hardware. Further, reflection of signals from buildings and objects in urban areas aggravates the problem. Accordingly, there is a need for a more efficient and cost friendly navigation apparatus for determining precise position of a device and thereby of a user associated with the device.

### SUMMARY

A method, apparatus, and computer program product are provided in accordance with an example embodiment described herein for determining a refined position of a mobile device are provided.

In one aspect, an apparatus for determining a refined position of a mobile device is disclosed. The apparatus comprising memory for storing instructions and a processor configured to execute the instructions to determine an initial position of the mobile device; determine a segment of a road associated with the initial position of the mobile device; process sound data recorded via a plurality of microphone sensors of the mobile device, wherein to process the sound data, the processor is further configured to determine a candidate pattern in the sound data; and determine the refined position of the mobile device based on the initial position of the mobile device, the candidate pattern and the determined segment of the road. An apparatus of example embodiments may further be caused to: determine directional characteristics of the candidate pattern relative to the segment of the road; and determine a side of the road where the device is, based on the directional characteristics relative to the segment of the road. The apparatus may be caused to control a display device to display a map that indicates the side of the road on which the device is, based on the refined position.

According to some embodiments, the apparatus may be caused to: receive destination data indicating a destination location to be reached; and control a display device to display navigation assistance data of a route between the refined position of the mobile device and the destination location.

According to some embodiments, the apparatus may be caused to determine the candidate pattern in the sound data by extraction of the candidate pattern from the sound data, based on implementation of a sound classifier with a trained data model. The apparatus may be caused to identify vehicle-based sound pattern, based on the sound classifier. The apparatus may further be caused to determine directional characteristics of the candidate pattern, based on whether the vehicle-based sound pattern emanates from a first lane of the road segment adjacent to the device or a second lane on the road segment opposite to the first lane. Additionally, the apparatus may be caused to identify background noise-based sound patterns in the sound data, based on the sound classifier, wherein the background-noise-based sound patterns are associated with 3D map model objects within a predetermined range of the initial location. The apparatus may further be caused to determine directional characteristics of the background noise-based sound patterns, based on reflection patterns associated with the 3D map model objects.

In another aspect, a method for determining a refined position of a mobile device is disclosed. The method comprises determining an initial position of the mobile device; determining a segment of a road associated with the initial position of the mobile device; processing sound data recorded via a plurality of microphone sensors of the mobile device, wherein the processing comprises determining a candidate pattern in the sound data; and determining the refined position of the mobile device based on the initial position of the mobile device, the candidate pattern and the determined segment of the road. Methods may include: determining directional characteristics of the candidate pattern relative to the segment of the road; and determining a side of the road where the device is, based on the directional characteristics relative to the segment of the road. The method may further include displaying a map that indicates the side of the road on which the device is, based on the refined position.

According to some example embodiments, the methods may include receiving destination data indicating a destination location to be reached; and displaying navigation assistance data of a route between the refined position of the mobile device and the destination location. The methods may include determining the candidate pattern in the sound data further comprises extracting the candidate pattern from the sound data, based on implementation of a sound classifier with a trained data model. The methods may further include identifying vehicle-based sound pattern as the candidate pattern, based on the sound classifier. The methods may further include determining directional characteristics of the candidate pattern based on whether the vehicle-based sound pattern emanates from a first lane of the road segment adjacent to the device or a second lane on the road segment opposite to the first lane.

According to some example embodiments, the methods may include identifying background noise-based sound patterns in the sound data, based on the sound classifier, wherein the background-noise-based sound patterns are associated with 3D map model objects within a predetermined range of the initial location. The methods may further include determining directional characteristics of the background noise-based sound patterns, based on reflection patterns associated with the 3D map model objects.

In yet another aspect, a non-transitory computer-readable medium having stored therein, computer-executable instructions for causing a computer to execute operations for determining a refined position of a mobile device, the operations comprising determining an initial position of the mobile device; determining a segment of a road associated with the initial position of the mobile device; processing sound data recorded via a plurality of microphone sensors of the mobile device, wherein the processing comprises determining a candidate pattern in the sound data; and determining the refined position of the mobile device based on the initial position of the mobile device, the candidate pattern and the determined segment of the road. non-transitory computer-readable medium may include program code instructions to determine directional characteristics of the candidate pattern relative to the segment of the road; and determine a side of the road where the device is, based on the directional characteristics relative to the segment of the road.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIGS. 1A and 1B illustrate an exemplary navigation scenario, in accordance with one or more example embodiments;

FIG. 2 illustrates a schematic block diagram of a communication diagram, in accordance with one or more example embodiments;

FIG. 3 illustrates a block diagram view of a mobile device, in accordance with one or more exemplary embodiments;

FIG. 4A illustrates a diagrammatic view of capture of sound data and processing carried out on the sound data, in accordance with one or more example embodiments;

FIG. 4B illustrates a diagrammatic view of display of the refined position of the mobile device based on the processing of the sound data; and

FIG. 5 illustrates a flowchart depicting steps in a method for determining a refined position of a mobile device, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The term “mobile device” may be used to refer to any user accessible device such as a mobile phone, a smartphone, a portable computer, and the like that is portable in itself or as a part of another portable object.

The term “initial position” may be used to refer to position of the mobile device as determined using a suitable position determination technique such as GNSS or network-based position determination techniques, fusion of such techniques, and the like.

The term “link” may be used to refer to any connecting pathway including but not limited to a roadway, a highway, a freeway, an expressway, a lane, a street path, a road, an alley, a controlled access roadway, a free access roadway and the like.

The term “route” may be used to refer to a path from a source location to a destination location on any link.

The term “segment of a road” may refer to a partition of a road along any direction. It may correspond to a part or whole of the road.

The term “candidate pattern” may refer to a predefined pattern of sound in terms of one or more of time, frequency, amplitude, phase, and the like that is a placeholder for differentiating between any sound and sound patterns that can be used for determining directionality.

The term “refined position” may refer to position of the mobile device as determined according to one or more embodiments of the present invention.

Traditionally, determining location of a user using a mobile device has been through commonly available techniques such as GNSS and network-based location determination techniques. Such techniques use triangulation methods wherein signal values greatly impact the accuracy of the determined location. For example, in urban clusters, apart from the incident signal, reflections of the incident signal from adjoining buildings also reach the sensors in the mobile device. Such reflections may introduce undesired effects and reduce the accuracy of the determined position. As such, a user requesting navigation assistance in such urban clusters may be assisted using an incorrect route due to inaccuracies in the determined position of the mobile device. In particular, assisting pedestrians and travelers traveling on or along a road requires precise determination of the position of the mobile device. An error in determining the side of the road on which the user is may lead to generation of incorrect navigation assistance data thereby incurring extra cost, additional time of travel, added maneuvers and/or detours, and mental agony on the part of the user. Commonly available techniques have not been able to address the aforesaid requirement. In fact, precision positioning indicating side of the road has been difficult and accuracy still depends on signal quality.

A method, apparatus, and computer program product are provided herein in accordance with an example embodiment for determining a refined position of a mobile device. In some example embodiments, the method, apparatus, and computer program product provided herein may also be used for determining a side of a road on which a user of the mobile device is. In some example embodiments, the method, apparatus, and computer program product provided herein may also be used for navigating a user to a destination location.

A method, apparatus, and computer program product provided herein in accordance with an example embodiment may be used for refining the position determined by a position sensor such as a GNSS sensor (e.g. GPS, Galileo, BaiDou, GLONASS receiver) and the like. The method, apparatus, and computer program product provided herein is for determining position of common user-held devices without the need for high precision positioning signals. The method, apparatus, and computer program product disclosed herein provide for utilization of available resources in these user-held devices to refine the location determined by known navigation systems such as GNSS and network-based positioning systems. Further, the method apparatus, and computer program product disclosed herein provide means for guiding pedestrians to the correct side of a street.

The method, apparatus, and computer program product disclosed herein provide for improved navigation experience, especially in dense urban areas where signals generally bounce from surrounding buildings. For example, the methods and apparatuses herein provide for deducing which side of road a device is, thus improving the overall navigation experience.

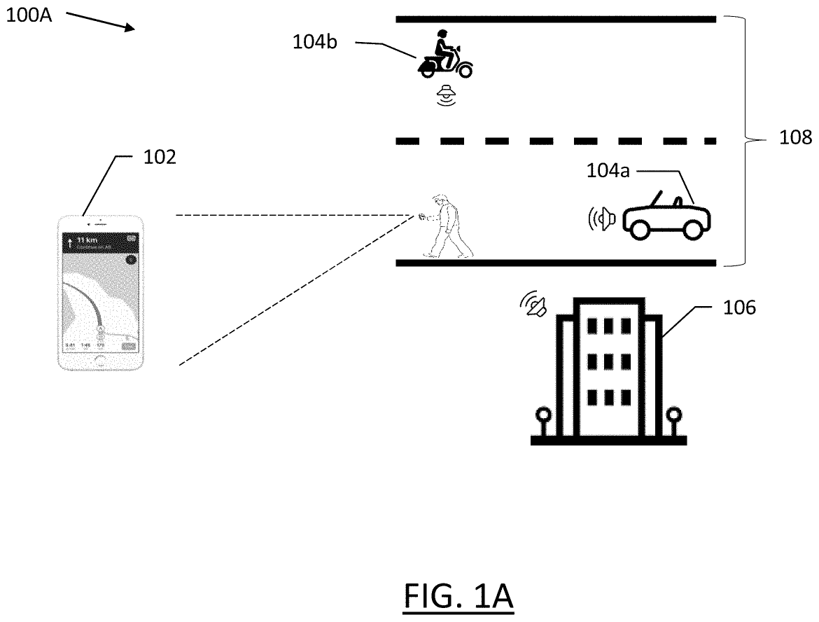

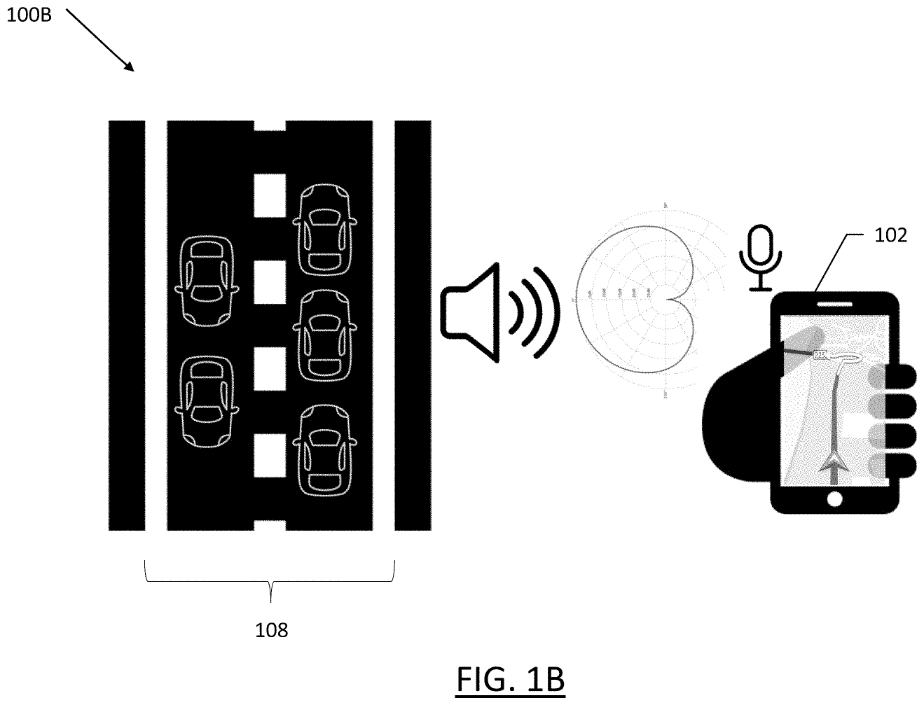

FIGS. 1A and 1B illustrate an exemplary navigation scenario, in accordance with one or more example embodiments. In the exemplary scenario 100A of FIG. 1A, a user carrying a mobile device 102 may be travelling along a stretch of a link 108. The link 108 may be a roadway, highway, waterway, street, alley, conduit, and the like. Hereinafter, the term ‘road’ and ‘link’ may be interchangeably used to represent the link 108 throughout the disclosure. In the exemplary scenario depicted in FIGS. 1A and 1B, the road 108 may be passing through an urban area witnessing heavy vehicular and traffic movement along with a high density of buildings and structures along the sides of the road 108. The road 108 may have one or more lanes with vehicles travelling in respective lanes of the one or more lanes, the direction of travel dictated as per the driving convention of the country/state in which the road 108 is located, e.g. driving on the left/driving on the right. In some example embodiments, the road 108 may be a one-way street having unidirectional vehicular movement. In some example embodiments, the road 108 may be amidst urban clusters such as buildings 106, witnessing normal or sparse traffic. Embodiments of the present disclosure are directed towards refining the conventionally determined position of the mobile device 102 based on audio processing of surrounding sounds. Embodiments of the present invention are capable of refining the conventionally determined position of the mobile device 102 even in a situation where a stationary vehicle with engine on, is parked on a one-way street. Accordingly, the surrounding sounds may comprise background noises and reflections from adjoining buildings 106 in alternate or addition to the traffic-based sound.

The user may be a traveler, a rider, a pedestrian, and the like who may be stationary or in motion with respect to the road 108. The user may wish to receive navigation assistance through a navigation application in the mobile device 102. The navigation assistance may correspond to, for example, route guidance, turn by turn navigation assistance, and the like. The mobile device 102 may be any user accessible device such as a mobile phone, a smartphone, a portable computer, and the like that is portable in itself or as a part of another portable/mobile object such as a vehicle. The mobile device may comprise processing means such as a central processing unit (CPU), storage means such as onboard read only memory (ROM) and random access memory (RAM), acoustic sensors such as a microphone array, position sensors such as a GPS sensor, orientation sensors such as gyroscope, motion sensors such as accelerometer, a display enabled user interface such as a touch screen display, and other components as may be required for specific functionalities of the mobile device 102. Additional, different, or fewer components may be provided. For example, the mobile device 102 may be configured to execute and run mobile applications such as a messaging application, a browser application, a navigation application, and the like.

The mobile device 102 may be configured to capture sound emanating from the surroundings of the mobile device 102. For example, in the exemplary scenario 100A described in FIG. 1A, the sound may emanate from passing by vehicles 104a and 104b on the road 108 and from adjoining buildings 106 along the side of the road. The surrounding sound may comprise vehicle-based sound generated from vehicles 104a and 104b and background noise-based sound. The background noise-based sound may comprise surrounding noise generated from adjoining buildings 106 and background reflections from the adjoining buildings 106.

The capture of surrounding sound by the mobile device 102 will next be described with reference to FIG. 1B. As is shown in FIG. 1B, an exemplary scenario 100B corresponding to the capture of surrounding sound by the mobile device 102 is depicted. The mobile device 102 may comprise two or more acoustic sensors such as a microphone array of a plurality of microphones. The plurality of microphones may transduce incoming audio into electrical signals. The performance of the microphones may typically be improved using one or more beamforming noise reduction algorithms for noise cancellation. Beamformers may use weighting and time-delay algorithms to combine the signals from the various microphones into a single signal. An adaptive post-filter may typically be applied to the combined signal to further improve noise suppression and audio quality of the captured sound signal. Any other noise cancellation techniques suitable for suppression of undesired noise may also be employed. In one or more example embodiments, the microphones of the microphone array may be employed based on orientation of the mobile device 102. For example, orientation data from orientation sensors of the mobile device 102 may be used in conjunction with the sound signals captured by the microphones to select the microphones whose signals are to be used for further processing. Such use cases may be of importance in cases where the mobile device 102 is hand held by the user.

In some example embodiments, the microphone array of the mobile device 102 may be a part of a directional audio system resident to the mobile device 102. Such directional audio systems may spatially filter received sound so that sounds arriving from a look direction (a desired direction) are accepted (constructively combined) and sounds arriving from other directions (undesired directions) are rejected (destructively combined). In some example embodiments, the arrangement of each of the plurality of microphones in the microphone array may be configured in a manner so as to capture data to be used for determining the directional characteristics of the surrounding sound. For example, the microphone array may capture stereo components of the surrounding sound. In or more example embodiments, the microphone array may capture a multi-channel sound as the surrounding sound. However, it may be contemplated that within the scope of this disclosure, in any case, a difference between sound captured by a first microphone sensor and sound captured by a second microphone sensor may be analyzed to determine directional characteristics of the sound.

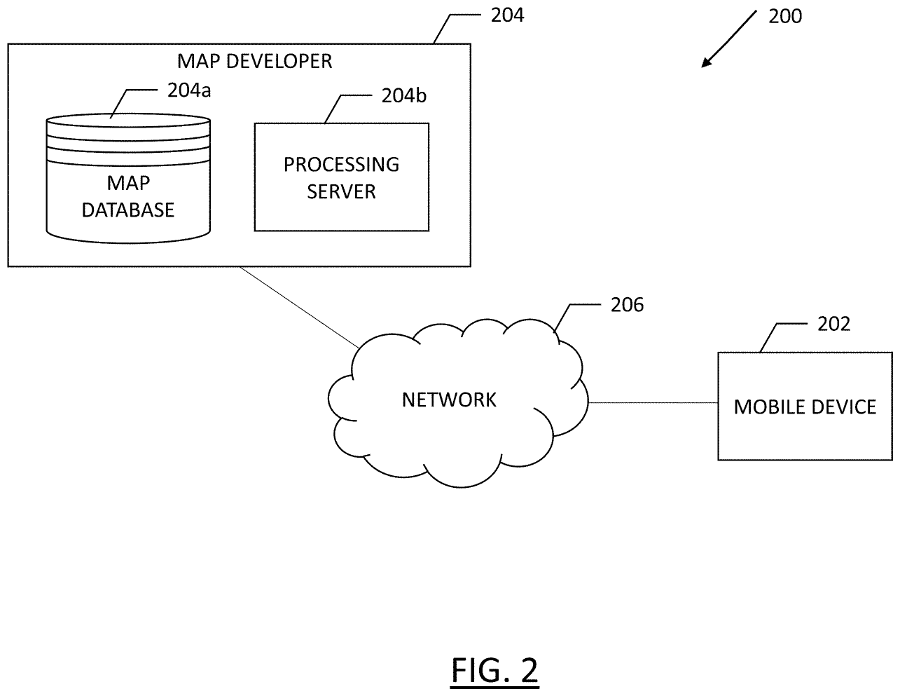

FIG. 2 illustrates a schematic block diagram of a communication diagram 200, in accordance with one or more example embodiments. In the communication diagram 200, a mobile device 202 may be communicatively coupled to a map developer system 204 via a communication network 206. The communication network 206 may be wired, wireless, or any combination of wired and wireless communication networks, such as cellular, Wi-Fi, internet, local area networks, or the like. The map developer system 204 may comprise a map database 204a for storing map data and a processing server 204b.

The map database 204a may store node data, road segment data, link data, point of interest (POI) data, link identification information, heading value records or the like. The map database 204a may also store cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 204a may contain path segment and node data records, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 204a may also store data about the POIs and their respective locations in the POI records. The map database 204a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 204a can include event data (e.g., traffic incidents, construction activities, scheduled events, unscheduled events, accidents, diversions etc.) associated with the POI data records or other records of the map database 204a. Optionally or additionally, the map database 204a may store 3D building maps data (3D map model of objects) of structures surrounding roads and streets.

The map database 204a may be maintained by a content provider e.g., a map developer. By way of example, the map developer may collect geographic data to generate and enhance the map database 204a. There may be different ways used by the map developer to collect data. These ways may include obtaining data from other sources, such as municipalities or respective geographic authorities. In addition, the map developer may employ field personnel to travel by vehicle along roads throughout the geographic region to observe features and/or record information about them, for example. Also, remote sensing, such as aerial or satellite photography, may be used to generate map geometries directly or through machine learning as described herein.

The map database 204a may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by user equipment such as the mobile device 202, for example. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 204a may be a master geographic database, but in alternate embodiments, the map database 204a may be embodied as a client-side map database and may represent a compiled navigation database that may be used in or with end user devices (e.g., the mobile device 202) to provide navigation and/or map-related functions. For example, the map database 204a may be used with the mobile device 202 to provide an end user with navigation features. In such a case, the map database 204a may be downloaded or stored on the mobile device 202.

The processing server 204b may comprise processing means and communication means. For example, the processing means may comprise one or more processors configured to process requests received from the mobile device 202. The processing means may fetch map data from the map database 204a and transmit the same to the mobile device 202 in a format suitable for use by the mobile device 202. In one or more example embodiments, the map developer system 204 may periodically communicate with the mobile device 202 via the processing means 204b to update a local cache of the map data stored on the mobile device 202. Accordingly, in some example embodiments, the map data may also be stored on the mobile device 202 and may be updated based on periodic communication with the map developer system 204.

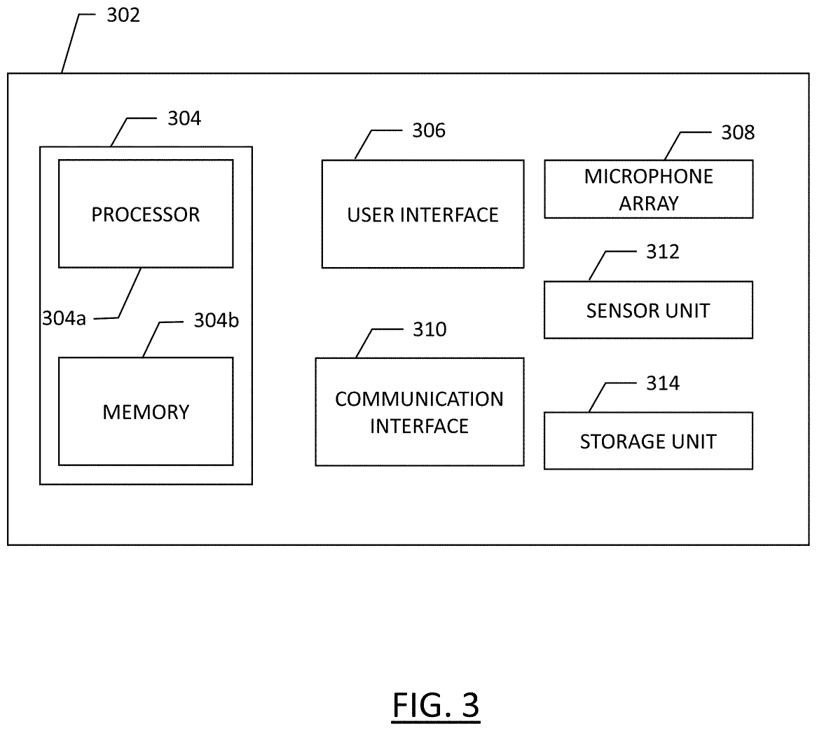

FIG. 3 illustrates a block diagram view of a mobile device 302, in accordance with one or more exemplary embodiments. The mobile device 302 may comprise an apparatus 304, a user interface 306, a microphone array 308, a communication interface 310, a sensor unit 312, and a storage unit 314. Additional, fewer, or different components may also be possible.

In some example embodiments, the apparatus 304 may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus 304 may therefore, in some cases, be configured to implement an example embodiment of the present invention on a single “system on a chip.” As such, in some cases, a chip or chipset may constitute a means for performing one or more operations for providing the functionalities described herein. Although, the apparatus 304 has been shown as a component of the mobile device 302, in some example embodiments, the mobile device 302 may itself be regarded as the apparatus 304, wherein the additional components (306-314) may be the components of the apparatus 304.

The apparatus 304 may comprise at least one processor 304a and at least one memory 304b. The processor 304a may be embodied in a number of different ways. For example, the processor 304a may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 304a may include one or more processing cores configured to perform independently. A multi-core processor may enable multiprocessing within a single physical package. Additionally, or alternatively, the processor 304a may include one or more processors configured in tandem via the bus to enable independent execution of instructions, pipelining and/or multithreading.

The memory 304b may be non-transitory and may include, for example, one or more volatile and/or non-volatile memories. For example, the memory 304b may be an electronic storage device (for example, a computer readable storage medium) comprising gates configured to store data (for example, bits) that may be retrievable by a machine (for example, a computing device like the processor 304a). The memory 304b may be configured to store information, data, content, applications, instructions, or the like, for enabling the apparatus to carry out various functions in accordance with an example embodiment of the present invention. For example, the memory 304b could be configured to buffer input data for processing by the processor 304a. Additionally, or alternatively, the memory 304b could be configured to store instructions for execution by the processor 304a.

The processor 304a (and/or co-processors or any other processing circuitry assisting or otherwise associated with the processor 304a) may be in communication with the memory 304b via a bus for passing information among components of the apparatus 304 and thus the mobile device 302. The processor 304a may be configured to execute instructions stored in the memory 304b or otherwise accessible to the processor 304a. Additionally, or alternatively, the processor 304a may be configured to execute hard coded functionality. As such, whether configured by hardware or software methods, or by a combination thereof, the processor 304a may represent an entity (for example, physically embodied in circuitry) capable of performing operations according to an embodiment of the present invention while configured accordingly. Thus, for example, when the processor 304a is embodied as an ASIC, FPGA or the like, the processor 304a may be specifically configured hardware for conducting the operations described herein. Alternatively, as another example, when the processor 304a is embodied as an executor of software instructions, the instructions may specifically configure the processor 304a to perform the algorithms and/or operations described herein when the instructions are executed. The processor 304a may include, among other things, a clock, an arithmetic logic unit (ALU) and logic gates configured to support operation of the mobile device 302.

The user interface 306 may be in communication with the apparatus 304 to provide output to the user and, in some embodiments, to receive an indication of a user input. As such, the user interface 306 may include a display and, in some embodiments, may also include a keyboard, a mouse, a joystick, a touch screen, touch areas, soft keys, one or more microphones, a plurality of speakers, or other input/output mechanisms. In one embodiment, the processor 304a may comprise user interface circuitry configured to control at least some functions of one or more user interface elements such as a display and, in some embodiments, a plurality of speakers, a ringer, s and/or the like. The processor 304a and/or user interface circuitry comprising the processor 304a may be configured to control one or more functions of one or more user interface elements through computer program instructions (for example, software and/or firmware) stored on the memory 304b accessible to the processor 304a. In some example embodiments, the user interface 306 may be embodied as a touch screen display. The user interface 306 may comprise one of a resistive type or a capacitive type touch surface as the user interface 306.

The microphone array 308 may comprise two or more microphone sensors arranged in a manner so as to capture directional components of the surrounding sound. In some example embodiments, the microphone array may be a stereo microphone, a microphone matrix or a suitable combination thereof. In some example embodiments, the microphone array 308 may be outside the mobile device 302 such as in the case of wired and wireless microphones. In such embodiments, the microphone array 308 may be communicatively coupled with the mobile device 302 through a network. Accordingly, the microphone array 308 may be embodied in a Bluetooth enabled headset or in a wired headset and the like. In some example embodiments, the microphone array 308 may be configured to capture stereo components of the surrounding sound. In some example embodiments, the microphone array 308 may be configured to capture at least the left (L) and right (R) components of the surrounding sound.

The communication interface 310 may comprise input interface and output interface for supporting communications to and from the mobile device 302. The communication interface 310 may be any means such as a device or circuitry embodied in either hardware or a combination of hardware and software that is configured to receive and/or transmit data to/from a communications device in communication with the mobile device 302. In this regard, the communication interface 310 may include, for example, an antenna (or multiple antennae) and supporting hardware and/or software for enabling communications with a wireless communication network. Additionally or alternatively, the communication interface 310 may include the circuitry for interacting with the antenna(s) to cause transmission of signals via the antenna(s) or to handle receipt of signals received via the antenna(s). In some environments, the communication interface 310 may alternatively or additionally support wired communication. As such, for example, the communication interface 310 may include a communication modem and/or other hardware and/or software for supporting communication via cable, digital subscriber line (DSL), universal serial bus (USB) or other mechanisms.

The sensor unit 312 may comprise one or more sensors. The one or more sensors may be configured to capture data of the mobile device 302. In some example embodiments, the one or more sensors may include position sensors such as the GNSS sensor for e.g. GPS, Galileo, GLONASS, BeiDou signals or the like, motion sensor such as accelerometer, magnetic field sensors such as a magnetometer and/or compass, orientation sensor such as a gyroscope, luminosity sensor, image sensor such as a camera and the like. In some example embodiments, the one or more sensors may capture data of the mobile device 302 such as but not limited to location of the mobile device 302, speed, acceleration, heading direction of the mobile device 302 and the like. In some example embodiments, the one or more sensors may capture the data in real-time or by using batch processing depending upon the type of OEM sensor installed in the mobile device 302.

The storage unit 314 may comprise one or more memory units to store data for use by the mobile device 302. The storage unit 314 may communicate with a cloud-based platform via the communication interface 310 to receive a trained data model that corresponds to data regarding candidate patterns of the surrounding sounds (candidate pattern data). For example, in some example embodiments, the candidate pattern data may be downloaded from the cloud-based platform to the storage unit 314 through an internet connection. Additionally, in some example embodiments, the storage unit 314 may be configured to store a full or partial copy of the map database 204a. In such cases, the storage unit 314 may communicate through the communication interface 310 to the map database 204a and download the map database 204a in full or part.

In some example embodiments, the candidate pattern data may be compiled by the cloud-based service provider or a vendor thereof using any suitable means and method. Such data may include for example, traffic sounds recorded for different vehicles, at different locations, and at different times. Additionally or alternately, the candidate pattern data may include for example, background reflections from urban structures such as buildings, trees, road infrastructures and the like. The candidate pattern data may be a robust repository that includes possibly all forms of sounds witnessed in all kinds of traffic, and in all orientations of the mobile device 302. Similarly, the candidate pattern data may comprise models of background noise reflected from the urban structures within a threshold distance from different locations in a traffic (on or along the road). The candidate pattern data may be used to build the trained data model. Any suitable training technique may be utilized to build the trained data model. The trained data model may include at least candidate patterns of vehicle-based sounds, candidate patterns of background noise, and candidate patterns of other types of noises. Such candidate patterns may be defined using for example, frequency domain analysis, temporal analysis, and the like.

The trained data model may be built considering various orientations of use cases of the mobile device 302. For example, the trained data model may be built considering that when the user is holding the mobile device 302, there may be some influence from the hand and the user's body in the way the sound is perceived. The training set may be created considering this, i.e. the trained data model may be built using data captured in a situation where a user is holding the phone in different orientations (for example with either left or right hand, in front of the body, and the like). It would be understood by a person having ordinary skill in the art that the orientation of the user with respect to the ground is relative to the orientation of the mobile device 302 with respect to the ground. For example, considering the case in which the mobile device 302 used for the capture of data for making the trained data model is hand held and has one or more on board microphones, the user holding the mobile device 302 may be facing the UI/screen of the mobile device 302 while the data is captured. In other words, whatever is behind the user and to the left, may be in front of the mobile device 302 and to the right—and vice versa. Thus, the data processing performed while building the trained data model should take the orientation of the user relative to the mobile device into consideration. In an example embodiment, the orientation of the perceived sound may be adjusted relative to the detected orientation or pose of the mobile device 302. This saves the need for having trained data modeled for all device orientations. Since the microphone sensors are fixed in the mobile device 302, rotations compensating for the mobile device's pose can be easily calculated. Alternately, in exemplary scenarios where the one or more microphones are external to the mobile device (as in case of wired and wireless microphones), the user's perspective and the mobile device's perspective are the same. In such scenarios, the microphones may be assumed (or detected, using in-built sensors in the microphone) to be facing in the same direction as the user and the data processing performed for building the trained data model should take this into consideration. Thus, the trained data model may be built based on the relative orientation of the user with respect to the mobile device 302.

Further, the trained data model may be built considering all types, volumes, and categories of vehicular traffic. For example, the training set may take into consideration, vehicle-based sounds from different vehicles. The training set may also take into consideration the vehicle-based sounds at different locations and different times of the day. Any other suitable technique may be utilized to build the trained data model to include candidate patterns of vehicle-based sounds.

Additionally or alternately, the trained data model may be built taking into consideration different types of background noises. For example, the trained data model may be built considering reflection patterns of sound from 3D buildings and other urban structures as received at different locations across the road. In some example embodiments, generalized shapes of 3D buildings, vegetations, large permanent structures etc. may be associated with exemplary sound patterns that are attributed to be reflections from these generalized shapes. As will be discussed later in this disclosure, this way, the trained data model may be utilized along with local map data to recognize candidate patterns of background reflections in surrounding sound captured by microphones of the mobile device 302. In some example embodiments, structures that are within a threshold distance from the location at which the sound is received for training the data model, may only be considered. The training set may also take into consideration the background noise at different locations and at different times of the day. Any other suitable technique may be utilized to build the trained data model to include candidate patterns of background noise.

Example embodiments of the present invention may provide a mechanism for determining a refined position of the mobile device 302. The user of the mobile device 302 may be for example, a pedestrian walking along a road. The user may request navigation assistance to reach a destination location from his current location/position. The processor 304a may first determine an initial position of the mobile device 302 as the current location/position of the mobile device 302. The mobile device 302 may utilize any suitable technique for example, a GNSS based location determination technique for this purpose. In some example embodiments, the processor 304a may receive geo coordinates using the position sensors of the sensor unit 312. Alternately or additionally, the processor 304a may determine the initial position using network-based location determination techniques.

The processor 304a may next determine a segment of the road along which the user is walking, using the initial position of the mobile device 302 and map data. For this purpose, the processor 304a may communicate with a server-side map database similar to the map database 204a of FIG. 2. In some example embodiments, the map database may be resident to the mobile device 302 itself, and as such the processor 304a may obtain the map data from the local map database. The segment of the road may correspond to a part or whole of the road. In some example embodiments, the segment of the road may include one or more lanes of the road. Although, example embodiments and the illustrated drawings of the disclosure describe a road having two lanes, it may be contemplated that this invention is capable of determining a side of a single lane or one-way roads as well. The processor 304a may employ any suitable technique to determine the segment of the road from the initial position and the map data, such as map matching techniques. For example, the processor 304a may fetch map data and locate a segment of the road having a predetermined length and/or width, by matching the initial position in the map data and fetching the segment of the road within a vicinity of the initial position.

The processor 304a may next record sound data of the surroundings in vicinity of the initial position. The processor 304a may control the microphone array 308 to record the sound data within a threshold range of the microphone array 308. The microphone array 308 may be configured to capture at least stereo components (L channel and R channel components) of the sound data of the surroundings. Next the processor 304a may perform audio processing/recognition on the recorded sound data. In some example embodiments, the processor 304a may communicate with the storage unit 314 to fetch the trained data model. The processor 304a may utilize the trained data model and the recorded sound data to determine one or more candidate patterns in the recorded sound data. For example, the processor 304a may extract at least candidate patterns of vehicle-based sound and/or candidate patterns of background noises from the recorded sound data, based on the trained data model. To this end, many different techniques may be utilized. For example, the one or more candidate patterns may be determined in the recorded sound data based on analysis in the frequency domain and time domain with the trained data model.

In some example embodiments, the one or more candidate patterns may be determined based on implementation of neural networks. For example, the one or more candidate patterns may be determined based on implementation of one or more sound classifiers and/or audio discriminators with the trained data model. In some example embodiments, a Hidden Markov Model (HMM) based classifier may be used to implement an audio recognition process with the trained data model to determine the one or more candidate patterns. The processor 304a may be configured to at least differentiate vehicle-based sounds and/or background reflection noises on buildings in the recorded sound data so as to determine candidate patterns of sounds emanating from vehicles and/or candidate patterns of background noise. The candidate patterns of background-noise may be associated with 3D map model objects within a predetermined range of the initial position of the mobile device 302.

In some example embodiments, the sound-based classifier may be utilized to discriminate vehicle-based sounds from background noise. The processor 304a may analyze attributes of the recorded sound data in time domain. For example, the processor 304a may be configured to feed the sound-based classifier to the recorded sound data and then perform a Fast Fourier Transformation of the time domain attributes of the recorded sound data. Then the processor 304a may discriminate the analyzed sound data in frequency domain to determine the vehicle-based sounds and the background noise in the recorded sound data. However, any suitable audio recognition technique may be employed for the aforesaid objective.

In one or more embodiments, the processor 304a may analyze the one or more candidate patterns to determine a direction of approach of the respective source(s). Firstly, an example embodiment is described considering the candidate patterns of vehicle-based sound to determine the direction of approach of the vehicle-based sound relative to the mobile device 302. Such determination of directional characteristics of the sound, as discussed previously, may be performed in the time domain as it allows for checking the differences in intensity between the left and right channels for a longer period of time. However, in a similar manner, the same procedure may be followed for the candidate pattern of background noise to determine the direction of approach of the background noise relative to the mobile device 302. The same has been described subsequently in the disclosure that follows.

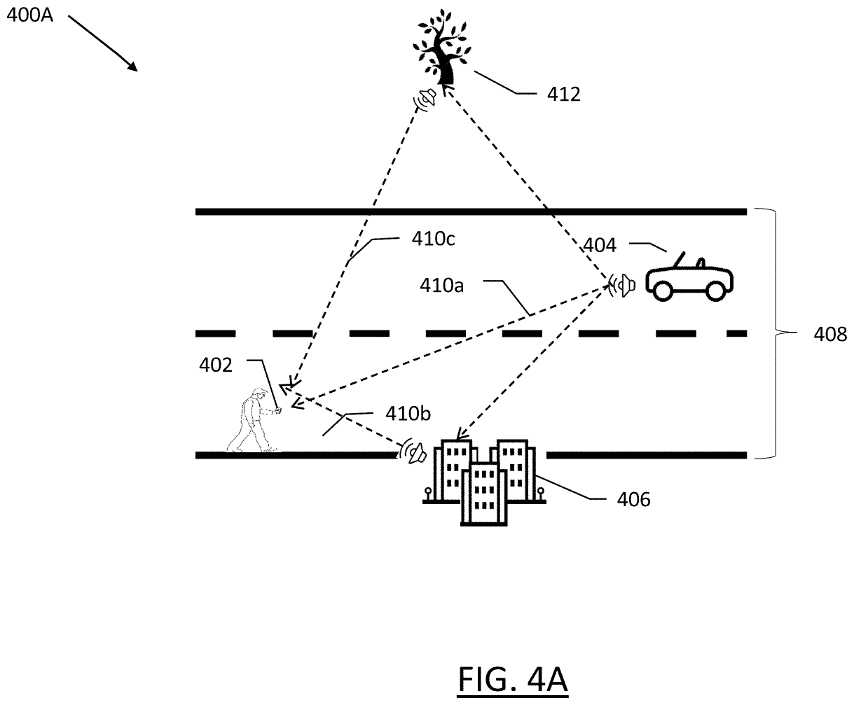

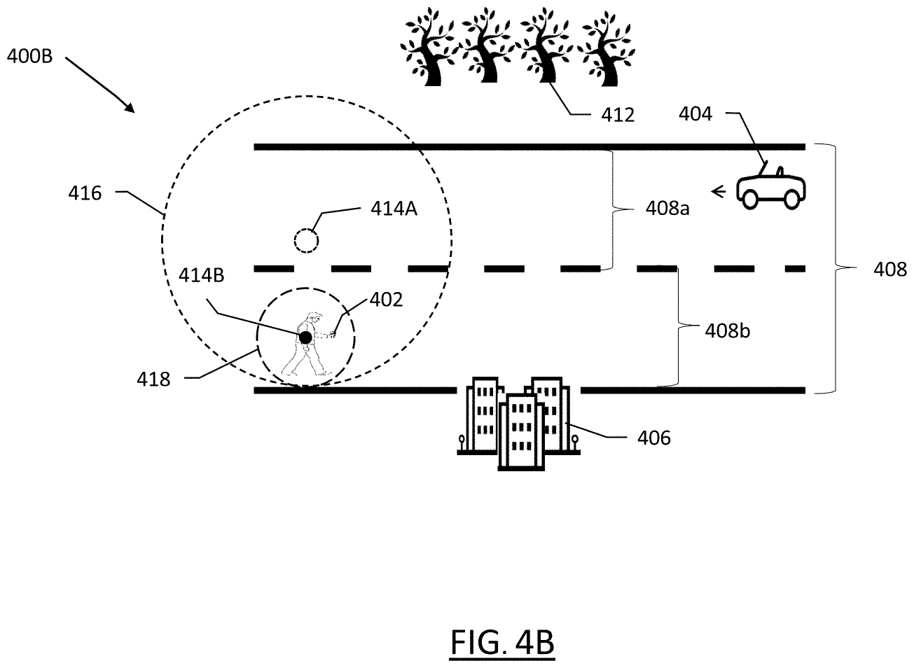

In some example embodiments, as is shown in FIG. 4A, a user, for example a pedestrian carrying a mobile device 402 may be walking along a segment of a road 408. At least one vehicle 404 may be approaching the user along a side of the road that is opposite to the side of the road 408 on which the user may be walking. There may be one or more urban clusters such as buildings 406 on the side of the road 408 along which the user may be walking and an open area with vegetation (parks, forests etc.) 412 on the other side of the road 408. In such a scenario, the mobile device 402 may capture surrounding sound in vicinity of the initial position in the manner discussed previously. In the exemplary embodiment depicted in FIG. 4A, the processor of the mobile device 402 may extract the candidate pattern of vehicle-based sound 410a emanating from the vehicle 404 and candidate pattern of the background noises 410b emanating/reflecting from the buildings 406 and 410c reflected/emanating from the vegetation 412.

Next the processor may compare the intensities of the candidate pattern of the vehicle-based sound 410a in the L channel and the R-channel. In some example embodiments, since the road may be on the right side of the mobile device 402, the R-channel component of the candidate pattern of the vehicle-based sound 410a may have a higher intensity than the L-channel component. The processor may then determine orientation of the mobile device 402 relative to the user. For example, the processor may determine connection state information of the microphone array that indicates whether the microphone array used for capturing the sound data is an onboard microphone array or an externally connected microphone array. Next the processor may obtain orientation data of the mobile device 402 (captured via one or more sensors such as accelerometers, compass, gyroscopes, IMUs and the like). Further, using the orientation data of the mobile device and the connection state information of the microphone array, the processor may determine the orientation of the mobile device 402 relative to the user. For example, in case the microphone array is detected to be onboard the mobile device 402 and is hand held by the user, the user would be facing the UI/screen of the mobile device 402. In other words, whatever is behind the user and to the left, will be in front of the mobile device 402 and to the right—and vice versa. Alternately, in case the microphone array is detected to be externally connected to the mobile device 402 (wearable microphones, e.g. as a wired or Bluetooth headset), the user's perspective would be the mobile device's perspective as well. In other words, the microphone sensors may be detected to be facing in the same direction as the user.

Returning to the scenario illustrated in FIG. 4A, since the microphone array is onboard the hand-held mobile device 402, the left-right orientations of the mobile device 402 and the user would be inverse of each other. Accordingly, based on the determined orientation of the mobile device 402 relative to the user and the intensity difference between the L-channel component and the R-channel component, the processor may determine that the vehicle 404 is on the left side of the user.

Further, in one or more exemplary embodiments, the processor may further analyze the candidate pattern of the vehicle-based sound 410a to determine the direction of approach of the vehicle-based sound 410a and thus the direction of approach of the vehicle 404. Any suitable technique such as a Doppler Effect based analysis may be performed on the vehicle-based sound 410a to determine the direction of approach of the vehicle 404. A person of ordinary skill in the art may recognize that Doppler Effect considers the variation in frequency or wavelength of a wave in relation to observer who is moving relative to the wave source. The processor may compare frequencies of the vehicle based-sound 410a and deduce whether the vehicle 404 is approaching the mobile device 402 or moving away from the mobile device 402. In this way, the direction of approach of the vehicle 404 relative to the mobile device 402 may be determined. In some example embodiments, the orientation of the mobile device 402 may also be taken into consideration to assist in the determination of the direction of approach of the vehicle 404. The processor may obtain orientation data of the mobile device 402 and deduce the direction of approach of the vehicle 404 relative to the orientation of the mobile device 402. In the example 400A illustrated in FIG. 4A, the processor may thus deduce that the vehicle 404 is approaching the mobile device 402 from the rear side and is on the left side of the user.

In some example embodiments, in a manner similar to that discussed above for the vehicle-based sound 410a, the direction of approach of the background noise 410b and 410c may be determined. The processor may compare intensities of the candidate pattern of the background noise 410b and 410c in the L-channel and the R-channel. In some example embodiments, since the building 406 (from which the background noise 410b emanates/reflects) may be on the left side of the mobile device 402 and the open area 412 (from which the background noise 410c emanates/reflects) may be on the right side of the mobile device 402, the processor may deduce that L-channel may receive background noise of higher intensity than the R-channel. The processor may thus determine that the L-channel component of the candidate pattern of the background noise 410b may have a higher intensity than the R-channel component, whereas the R-channel component of the candidate pattern of the background noise 410c may have a higher intensity than the L-channel component. Accordingly, the processor may determine that the building 406 is on the left side of the mobile device 402 and the vegetation 412 may be on the right side of the mobile device 402. In some example embodiments, the processor may determine the directionality (directional characteristics) of the candidate pattern of the background noise 410b based on reflection patterns associated with the building 406. Further, in one or more exemplary embodiments, the processor may utilize local knowledge of the surrounding structures (as available from 3D building maps) to determine the side of the road on which the building 406 is. For example, when determining the candidate patterns of the background noises 410b and 410c, the processor may also determine the generalized shapes associated with each of the determined candidate patterns of the background noises 410b and 410c. This may include comparing the sound patterns in the captured sound data with sound patterns associated with generalized shapes of 3D building models. Thus, the processor may be configured to determine the generalized shapes associated with each of the candidate patterns of the background noises 410b and 410c. The processor may then refer to the 3D map data of an area within vicinity of the initial position to match the determined generalized shapes with one or more 3D building models in the 3D map data. For example, the generalized shape associated with the candidate pattern may match with a 3D building (406) while the generalized shape associated with the candidate pattern of the background noise 410c may match with a vegetation (412) in the 3D map data. The processor may analyze the determined matches to determine that the building 406 is on left of the mobile device 402 while the vegetation is on the right. Further, since the intensity of the background noise 410b would be greater than the intensity of the background noise 410c, the processor may determine that the mobile device is closer to the building 406 than the vegetation.

Based on the relative location of the vehicle 404 and/or the noise sources (building 406 and vegetation 412), the processor may thus determine on which side of the road 408 the mobile device 402 is relative to the road 408. In this way, the initial position 414A (as detected by position sensor) of the mobile device 402 may be further refined based on the determined relative positions of the vehicle 404 and/or adjoining noise sources (building 406 and vegetation 412). Thus, a refined position 414B of the mobile device 402 relative to the segment of the road 408 may be determined based on the processing carried out on the one or more candidate patterns extracted from the captured surrounding sound.

In some example embodiments, the refinement of the initial position of the mobile device 402 may be discussed with reference to FIG. 4B. The initial position 414A of the mobile device 402 on the road 408 as determined by one or more position sensors may be on a lane 408a with an offset area 416 as shown in the exemplary embodiment 400B depicted in FIG. 4B. As discussed with reference to FIG. 4A, the processor of the mobile device 402 may determine that the mobile device 402 is closer to the building 406 than the vegetation 412 and thus deduce that the mobile device 402 is along the lane 408b and not 408a. With reference to FIG. 4B, it may be seen that the refined position 414B of the mobile device 402 may be on the lane 408b. Thus, the processor may precisely deduce side of the road 108 the mobile device 402 is, thereby aiding in accurate navigation assistance to the user. Considering the initial position 414, navigational guidance provided to the user may be erroneous, thereby causing mental agony and incurring extra travel to the user. The methods as depicted in exemplary embodiments above mitigates this issue by providing the refined position 418 as the accurate position of the mobile device 402.

In some example embodiments, the processor may obtain map data in the manner discussed previously and control display of the refined position on the map of the area in which the road segment lies. The refined position may not necessarily be limited to the representation shown in FIG. 4B but may encompass any graphical representation that indicates the side of the road on which the user is. For example the area 418 may be highlighted in appropriate color to indicate that the user is on the side of the road corresponding to lane 408b. Additionally or optionally, the processor may receive a destination location from the user and fetch navigation assistance data regarding a route between the refined position of the mobile device 402 and the destination location. The processor may thus control output of the navigation assistance data to the user of the mobile device 402. In some example embodiments, the processor may execute a navigation application to provide the navigation assistance. The navigation assistance may include amongst other things, navigation instructions to the user such as “please cross the street”, “you will find the destination on this side/opposite side of the street”, “please continue to walk on this side of the street”, “after turning left/right, please cross the street” and the like.

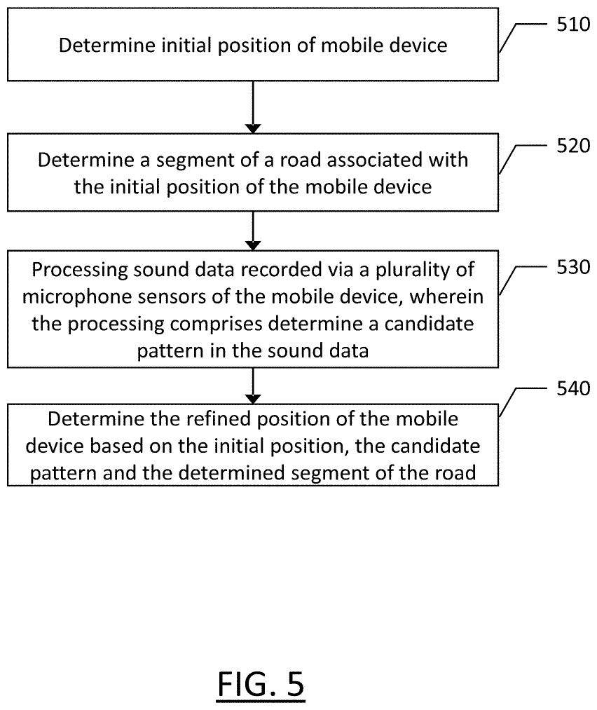

FIG. 5 illustrates a flowchart illustrative of a method according to example embodiments of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 5 illustrates a method for determining a refined position of a mobile device according to an example embodiment of the present invention. The method comprises at 510, determining an initial position of the mobile device. At 520, determining a segment of a road associated with the initial position of the mobile device. The method further comprises at 530, processing sound data recorded via a plurality of microphone sensors of the mobile device. The step of processing the sound data may further comprise determining a candidate pattern in the sound data. The step of determining the candidate pattern in the sound data may further comprise extracting the candidate pattern from the sound data, based on implementation of a sound classifier with a trained data model. The extraction of the candidate pattern may comprise identifying vehicle-based sound pattern as the candidate pattern, based on the sound classifier. Additionally or optionally, the extraction of the candidate patterns may comprise identifying background noise-based sound patterns in the sound data, based on the sound classifier. The background-noise-based sound patterns may be associated with 3D map model objects within a predetermined range of the initial position. The directional characteristics of the background noise-based sound patterns may be determined based on reflection patterns associated with the 3D map model objects. Additionally or optionally, the directional characteristics of the candidate pattern may be determined based on whether the vehicle-based sound pattern emanates from a first lane of the road segment adjacent to the device or a second lane on the road segment opposite to the first lane. The method further comprises at 540, determining the refined position of the mobile device based on the initial position, the candidate pattern and the determined segment of the road.

Additionally, various other steps not shown in FIG. 5 may also be included in the method. For example, the method may further comprise determining directional characteristics of the candidate pattern relative to the segment of the road. The method may further comprise determining a side of the road where the device is, based on the directional characteristics relative to the segment of the road. Additionally or optionally, the method may further comprise displaying a map that indicates the side of the road on which the device is, based on the refined position. The method may further comprise receiving destination data indicating a destination location to be reached and displaying navigation assistance data of a route between the refined position of the mobile device and the destination location.

In an example embodiment, an apparatus (e.g., the apparatus 304) for performing the method of FIG. 5 above may comprise a processor (e.g., the processor 304a) configured to perform some or each of the operations (510-540) described above. The processor may, for example, be configured to perform the operations (510-540) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 510-550 may comprise, for example, the processor 304a and/or a device or circuit for executing instructions or executing an algorithm for processing information as described above.

In this way, example embodiments of the invention result in determination of a precise and more refined position/location of a user in comparison to the position determined by conventional positioning techniques. Especially, in urban clusters, due to reception of weak signals, the conventionally determined location may be offset to a greater extent from the actual location of the mobile device. As such, embodiments described herein refine the position by determining the side of the road on which the mobile device is. In case of the user being a driver of a vehicle, embodiments described herein are capable of determining the lane in which the user is driving by determining the side of road on which approaching/receding vehicles are and their respective direction of approach. Thus, the unique methodology described herein, pertaining to accurate determination of position without use of any extra components, provides for generation of high precision navigation assistance data. In this way, embodiments of the claimed invention add an enhanced capability to the mobile device and thus result in improvement of the mobile device itself.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for determining a refined position of a mobile device, the apparatus comprising:
a memory configured to store instructions;
a processor configured to execute the instructions to:
determine an initial position of the mobile device;
determine a segment of a road associated with the initial position of the mobile device;
process sound data recorded via a plurality of microphone sensors of the mobile device, wherein to process the sound data, the processor is further configured to determine a candidate pattern in the sound data; and
determine the refined position of the mobile device based on the initial position of the mobile device, the candidate pattern and the determined segment of the road.

2. The apparatus of claim 1, wherein the processor is further configured to:
determine directional characteristics of the candidate pattern relative to the segment of the road; and
determine a side of the road where the device is, based on the directional characteristics relative to the segment of the road.

3. The apparatus of claim 2, wherein the processor is further configured to control a display device to display a map that indicates the side of the road on which the device is, based on the refined position.

4. The apparatus of claim 2, wherein the processor is further configured to:'
receive destination data indicating a destination location to be reached; and
control a display device to display navigation assistance data of a route between the refined position of the mobile device and the destination location.

5. The apparatus of claim 1, wherein the processor is further configured to determine the candidate pattern in the sound data by extraction of the candidate pattern from the sound data, based on implementation of a sound classifier with a trained data model.

6. The apparatus of claim 5, wherein the processor is further configured to identify vehicle-based sound pattern, based on the sound classifier.

7. The apparatus of claim 6, wherein the processor is further configured to determine directional characteristics of the candidate pattern, based on whether the vehicle-based sound pattern emanates from a first side of the road segment adjacent to the device or a second side of the road segment opposite to the first side.

8. The apparatus of claim 5, wherein the processor is further configured to:
identify background noise-based sound patterns in the sound data, based on the sound classifier,
wherein the background-noise-based sound patterns are associated with 3D map model objects within a predetermined range of the initial position.

9. The apparatus of claim 8, wherein the processor is further configured to determine directional characteristics of the background noise-based sound patterns, based on reflection patterns associated with the 3D map model objects.

10. A method for determining a refined position of a mobile device, the method comprising:
determining an initial position of the mobile device;
determining a segment of a road associated with the initial position of the mobile device;
processing sound data recorded via a plurality of microphone sensors of the mobile device, wherein the processing comprises determining a candidate pattern in the sound data; and
determining the refined position of the mobile device based on the initial position of the mobile device, the candidate pattern and the determined segment of the road.

11. The method of claim 10, further comprising:
determining directional characteristics of the candidate pattern relative to the segment of the road; and
determining a side of the road where the device is, based on the directional characteristics relative to the segment of the road.

12. The method of claim 11, further comprising displaying a map that indicates the side of the road on which the device is, based on the refined position.

13. The method of claim 11, further comprising:
receiving destination data indicating a destination location to be reached; and
displaying navigation assistance data of a route between the refined position of the mobile device and the destination location.

14. The method of claim 10, wherein determining the candidate pattern in the sound data further comprises extracting the candidate pattern from the sound data, based on implementation of a sound classifier with a trained data model.

15. The method of claim 14, further comprising identifying vehicle-based sound pattern as the candidate pattern, based on the sound classifier.

16. The method of claim 15, further comprising determining directional characteristics of the candidate pattern based on whether the vehicle-based sound pattern emanates from a first side of the road segment adjacent to the device or a second side of the road segment opposite to the first side.

17. The method of claim 14, further comprising:
identifying background noise-based sound patterns in the sound data, based on the sound classifier,
wherein the background-noise-based sound patterns are associated with 3D map model objects within a predetermined range of the initial location.

18. The method of claim 17, further comprising determining directional characteristics of the background noise-based sound patterns, based on reflection patterns associated with the 3D map model objects.

19. A non-transitory computer readable medium having stored therein, computer-executable instructions for causing a computer to execute operations for determining a refined position of a mobile device, the operations comprising:
determining an initial position of the mobile device;
determining a segment of a road associated with the initial position of the mobile device;
processing sound data recorded via a plurality of microphone sensors of the mobile device, wherein the processing comprises determining a candidate pattern in the sound data; and
determining the refined position of the mobile device based on the initial position of the mobile device, the candidate pattern and the determined segment of the road.

20. The non-transitory computer readable medium of claim 19, wherein the operations further comprise:
determining directional characteristics of the candidate pattern relative to the segment of the road; and
determining a side of the road where the device is, based on the directional characteristics relative to the segment of the road.
